(19) United States
(12) Patent Application Publication
(10) Pub. No.: US 2015/0136185 A1
(43) Pub. Date: May 21, 2015

(54) APPARATUS OF CLEANING SUBSTRATE

(71) Applicant: SAMSUNG DISPLAY CO., LTD., Yongin-City (KR)

(72) Inventors: JUNGWON JO, Cheonan-si (KR); CHUNGHYUK LEE, Yongin-si (KR); Joon NAM, Cheonan-si (KR); SEONG GU KANG, Seoul (KR); HAK KIM, Seoul (KR); SungKu BAEK, Yongin-si (KR); KYUNGJAE LEE, Asan-si (KR)

(21) Appl. No.: 14/453,447

(22) Filed: Aug. 6, 2014

(30) Foreign Application Priority Data
Nov. 19, 2013 (KR) 10-2013-0140683

(51) Int. Cl. B08B 3/02; B08B 13/00

(52) U.S. Cl. CPC B08B 3/02; B08B 13/00
USPC 134/103.2; 134/198

(57) ABSTRACT

Provided is a substrate cleaning apparatus of cleaning a substrate. The substrate cleaning apparatus includes a cleaning chamber, a first cleaning nozzle, a cover member, an air flow generation unit, and an exhaust unit. The main cleaning chamber has a cleaning space in which the substrate is cleaned and includes a sidewall in which a first vent hole is defined. The first cleaning nozzle is disposed in the main cleaning chamber to spray a first cleaning solution. The cover member covers the main cleaning chamber and has one side in which a second vent hole is defined. The air flow generation unit supplies air into the cleaning space through the first vent hole. The exhaust unit is coupled to the one side of the cover member to suck and exhaust the air supplied into the cleaning space through the second vent hole.

### CROSS-REFERENCE TO RELATED APPLICATIONS

This U.S. non-provisional patent application claims priority under 35 U.S.C. §119 to Korean Patent Application No. 10-2013-0140683, filed on Nov. 19, 2013, the entire contents of which are hereby incorporated by reference.

### BACKGROUND

The present disclosure herein relates to an apparatus of cleaning a substrate, and more particularly, to an apparatus of wet-cleaning a substrate.

When a flat panel display device is manufactured, a plurality of processes including a cleaning process may be performed on a substrate such as a glass substrate. To clean a large-area glass substrate for the flat panel display device, the substrate is carry into a cleaning chamber to spray a cleaning solution onto the substrate through a plurality of nozzles disposed within the cleaning chamber, thereby cleaning the substrate.

The plurality of nozzles may be classified into several types according to a discharge pressure of the cleaning solution. Also, methods of cleaning the substrate by using the cleaning solution may be somewhat different according to the discharge pressure. For example, the plurality of nozzles may include a water jet nozzle, a shower nozzle, and a spray nozzle. The water jet nozzle may discharge the cleaning solution at a pressure greater than those of the shower nozzle and the spray nozzle. The water jet nozzle may clean the substrate by using the cleaning solution discharged therefrom. In addition, the cleaning solution may hit the substrate at a high pressure to more effectively remove foreign substances such as particles and impurities adhered to the substrate.

### SUMMARY

The present disclosure provides a substrate cleaning apparatus which is capable of preventing a cleaned substrate from being contaminated.

Embodiments of the inventive concept provide substrate cleaning apparatuses of cleaning a substrate including a cleaning chamber, a first cleaning nozzle, a cover member, an air flow generation unit, and an exhaust unit. The main cleaning chamber has a cleaning space in which the substrate is cleaned and includes a sidewall in which a first vent hole is defined. The first cleaning nozzle is disposed in the main cleaning chamber to spray a first cleaning solution. The cover member covers the main cleaning chamber and has one side in which a second vent hole is defined. The air flow generation unit supplies air into the cleaning space through the first vent hole. The exhaust unit is coupled to the one side of the cover member to suck and exhaust the air supplied into the cleaning space through the second vent hole.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1A is a perspective view of a substrate cleaning apparatus according to an embodiment of the inventive concept;

FIG. 1B is a cross-sectional view of the substrate cleaning apparatus of FIG. 1A;

FIGS. 2A and 2B are views illustrating a state in which mist is generated in a main cleaning chamber of FIG. 1B; and

FIGS. 3A, 3B, and 3C are views illustrating an operation for exhausting the mist by the substrate cleaning apparatus.

### DETAILED DESCRIPTION OF THE EMBODIMENTS

Exemplary embodiments of the inventive concept will be described below in more detail with reference to the accompanying drawings. The objects, characteristics and effects of the inventive concept will become apparent with the detailed descriptions of the preferred embodiment and the illustrations of related drawings as follows. The present disclosure may, however, be embodied in different forms and should not be construed as limited to the embodiments set forth herein. Rather, these embodiments are provided so that this disclosure will be thorough and complete, and will fully convey the scope of the inventive concept to those skilled in the art. Accordingly, the scope of the inventive concept should not be construed as being limited to the above described embodiments. In the embodiments and drawings, like reference numerals refer to like elements throughout.

It will be understood that although the terms ‘first’ and ‘second’ are used herein to describe various elements, these elements should not be limited by these terms. It will be understood that when a layer, a region, or an element is referred to as being ‘on’ another layer, region, or element, it can be formed directly on the other layer, region, or element, or it can be formed with intervening layers, regions, or elements.

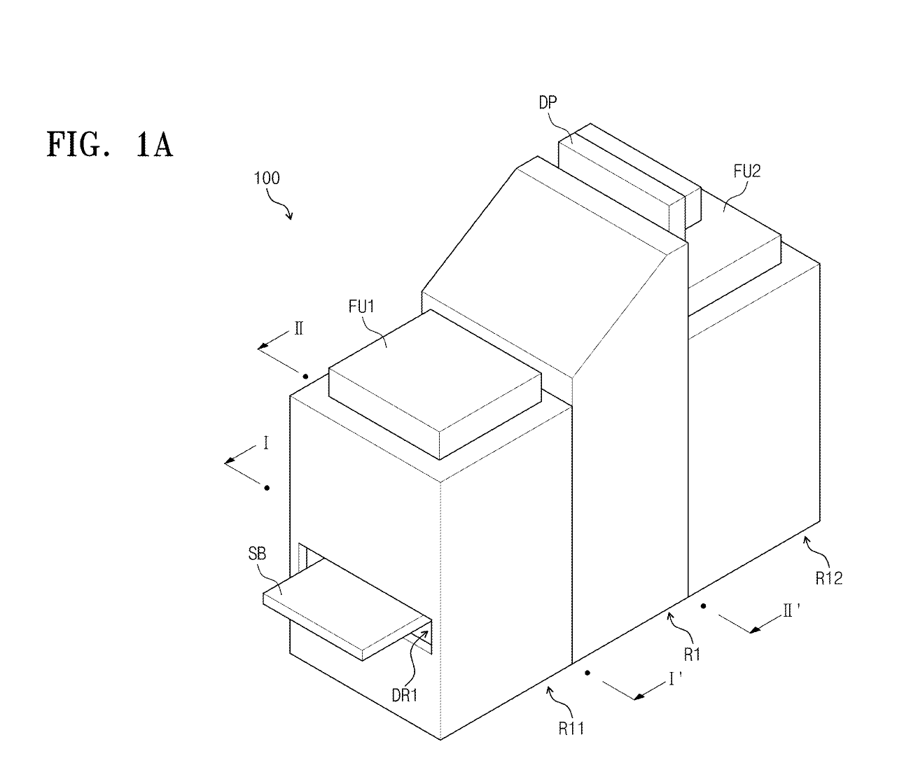

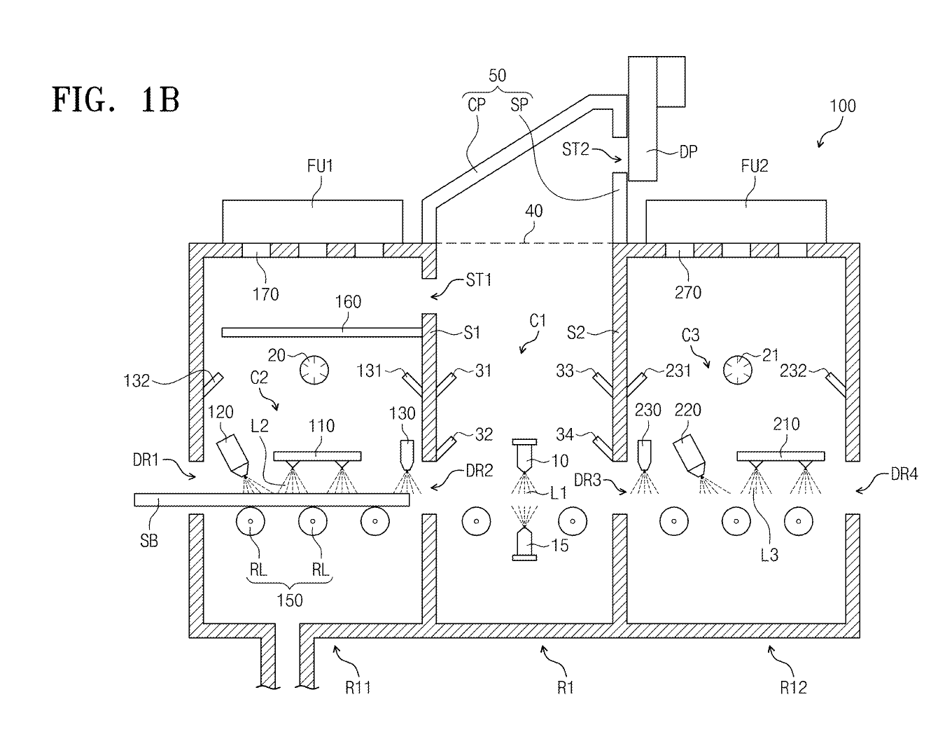

FIG. 1A is a perspective view of a substrate cleaning apparatus 100 according to an embodiment of the inventive concept, and FIG. 1B is a cross-sectional view of the substrate cleaning apparatus 100 of FIG. 1A.

Referring to FIGS. 1A and 1B, the substrate cleaning apparatus 100 may be an apparatus for performing a cleaning process of a substrate SB. In the current embodiment, the substrate cleaning apparatus 100 includes a transfer unit 150, a first auxiliary cleaning chamber R11, a main cleaning chamber R1, and a second auxiliary cleaning chamber R12. The first auxiliary cleaning chamber R11, the main cleaning chamber R1, and the second auxiliary cleaning chamber R12 are successively arranged.

A substrate input hole DR1 is disposed in an outer wall of the first auxiliary cleaning chamber R11, and a first substrate entrance DR2 is formed between the first auxiliary cleaning chamber R11 and the main cleaning chamber R1. Also, a second substrate entrance DR3 is formed between the second auxiliary cleaning chamber R12 and the main cleaning chamber R1, and a substrate output hole DR4 is formed in an outer wall of the second auxiliary cleaning chamber R12.

The transfer unit 150 is disposed inside the first auxiliary cleaning chamber R11, the main cleaning chamber R1, and the second auxiliary cleaning chamber R12. Thus, after the substrate SB is entered into the substrate cleaning apparatus 100 through the substrate input hole DR1, the substrate 100 may be sequentially transferred to the first auxiliary cleaning chamber R11, the main cleaning chamber R1, and the second auxiliary cleaning chamber R12. Also, after finishing the cleaning process, the transfer unit 150 may operate to take the substrate SB out of the substrate cleaning apparatus 100 through the substrate output hole DR4.

In the current embodiment, the transfer unit 150 may include a plurality of rollers RL. In this case, the substrate SB may be disposed on the plurality of rollers RL and then transferred by rotation force of the plurality of rollers RL. According to another embodiment, the transfer unit 150 may operate in a different manner using a transfer belt or transfer rail to transfer the substrate SB.

The main cleaning chamber may include sidewalls including a first sidewall S1 in which a first vent hole is disposed, a second sidewall S2 opposing the first sidewall, a third sidewall connecting the first sidewall and the second sidewall, and a fourth sidewall connecting the first sidewall and the second sidewall and opposing the third sidewall. Thus, a first cleaning space C1 is defined by the plurality of sidewalls and a cover part CP. First cleaning nozzles 10 and 15 and first to fourth blocking members 31, 32, 33, and 34 are disposed within the main cleaning chamber R1.

One of the first cleaning nozzles 10 and 15 is disposed above the substrate SB to spray a first cleaning solution L1 onto a top surface of the substrate SB, and the other one of the first cleaning nozzles 10 and 15 is disposed below the substrate SB to spray the first cleaning solution L1 onto a bottom surface of the substrate SB. Thus, the substrate SB may be cleaned by the first cleaning solution L1 that is sprayed from the first cleaning nozzles 10 and 15.

In the current embodiment, the first cleaning solution L1 may be distilled water (DW) or deionized water (DIW). However, the present disclosure is not limited to a kind of first cleaning solution L1. For example, according to another embodiment, the first cleaning solution L1 may include isopropyl alcohol (IPA).

In the current embodiment, the first cleaning nozzles 10 and 15 may be water jet nozzles. Each of the first cleaning nozzles 10 and 15 may discharge the first cleaning solution L1 generated by a high-pressure pump at a pressure of about 100 bar. Thus, the substrate SB may be cleaned by components of the first cleaning solution L1. In addition, the first cleaning solution L1 may easily clean foreign substances adhered to the substrate SB by physical force that hits the substrate SB at a high pressure.

A first vent hole ST1 is disposed on an upper portion of the first sidewall S1 formed between the first auxiliary cleaning chamber R11 and the main cleaning chamber R1. Air may be supplied from the first auxiliary cleaning chamber R11 to the main cleaning chamber R1 through the first vent hole ST1.

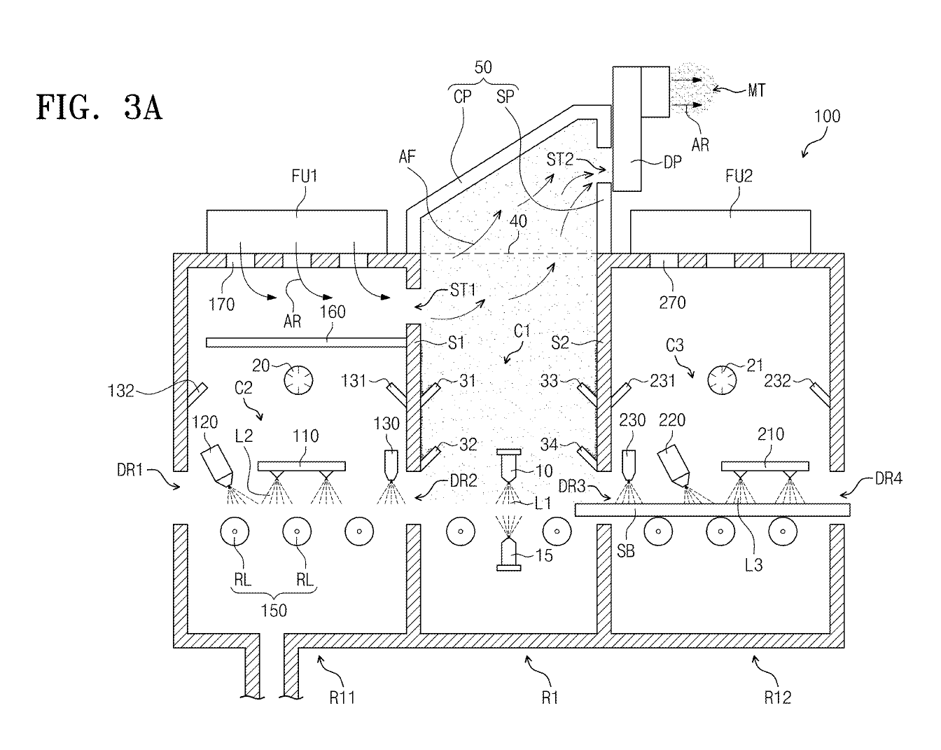

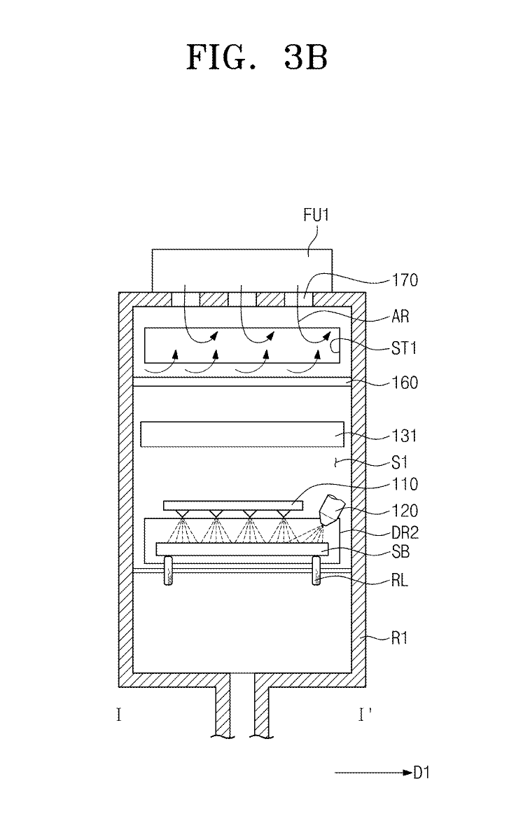

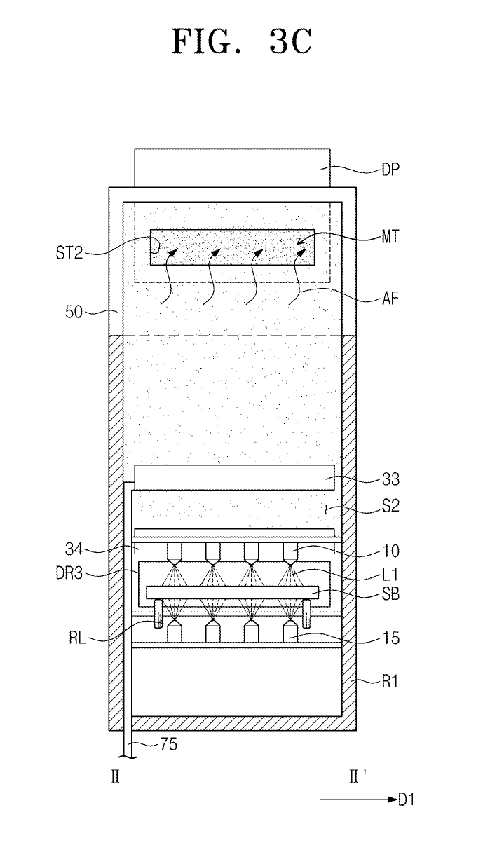

In the current embodiment, as shown in FIG. 3B, the first vent hole ST1 may extend in a width direction (a direction D1 in FIG. 3B) of the substrate cleaning apparatus 100. Also, the first vent hole ST1 may have a length direction parallel to the width direction (the direction D1 in FIG. 3B) the substrate cleaning apparatus 100.

A cover member 50 covers the main cleaning chamber R1. The cover member is disposed on the main cleaning chamber R1. In the current embodiment, the cover member 50 includes a side part SP, an opposing side part opposing the side part SP and a cover part CP coupled to the side part SP and the opposing side part to cover an upper portion of the main cleaning chamber. The side part SP has a first height and the opposing part has a second height smaller than the first height. The cover part inclines toward opposing side part. In the current embodiment, the cover member 50 may be formed of a transparent material such as an acrylic resin. The cover member 50 may be separated from the main cleaning chamber R1.

A second vent hole ST2 is disposed on the side part SP. Thus, the air supplied from the first auxiliary cleaning chamber R11 to the main cleaning chamber R1 through the first vent hole ST1 may be discharged to the outside of the main cleaning chamber R1 through the second vent hole ST2.

In the current embodiment, as shown in FIG. 3C, the second vent hole ST2 may extend in a width direction (a direction D1 in FIG. 3C) of the side part SP. As a result, each of the first and second vent holes ST1 and ST2 may have a length direction parallel to the width direction (the direction D1 in FIG. 3C) of the substrate cleaning apparatus 100.

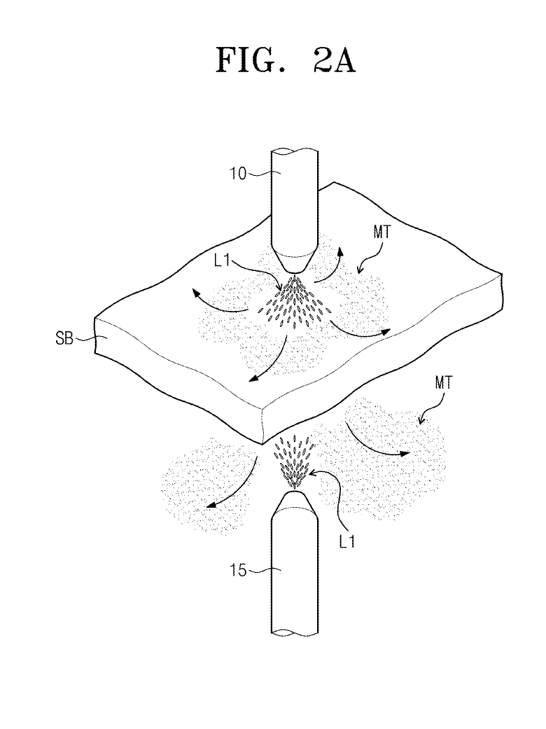

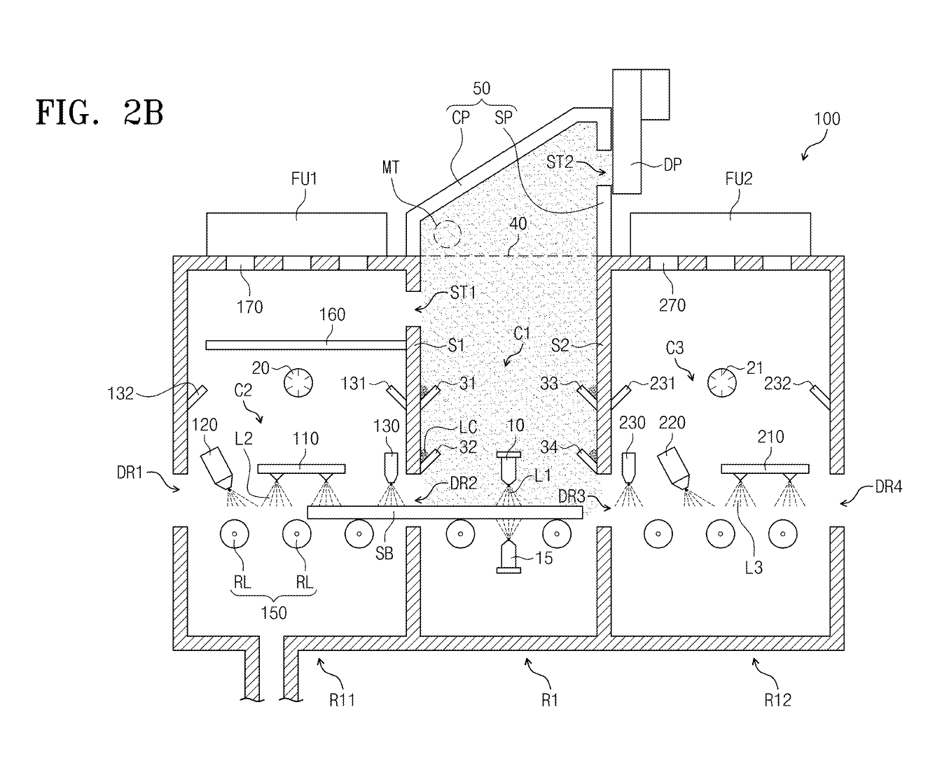

The cover part CP is coupled to the side part SP to cover an upper side of the main cleaning chamber R1. In the current embodiment, the cover part CP may be tilted from the second vent hole ST2 toward the first vent hole ST1 in a side view. Thus, even though mist (see reference symbol MT of FIG. 2A) generated by the cleaning process that is performed in the first cleaning space C1 is condensed into dew on the cover part CP, liquid generated by the condensed mist may not drop to the substrate SB, but flow down along the cover part CP and the first sidewall S1.

Most of the liquid may include the first cleaning solution L1 that is used in the main cleaning chamber R1. However, while the liquid is condensed into dew on the cover part CP, the liquid may be contaminated by particles and bacteria remained on the cover part CP. Thus, as described above, the dropping of the liquid onto the substrate SB may cause contamination of the substrate. The tilted cover part CP prevents the substrate SB from being contaminated by the liquid dropped from the cover part.

Also, when the air is supplied from the auxiliary cleaning chamber R11 into the main cleaning chamber R1 through the first vent hole ST1, the air may be easily guided to the second vent hole ST2 by the tilted shape of the cover part CP. Thus, air turbulence may not occur while the air flows via the main cleaning chamber R1.

In the current embodiment, the cover part CP may be tilted at an angle of about 20 degrees to about 50 degrees with respect to a horizontal line 40 connecting the ceiling of the first auxiliary cleaning chamber R11 and the second auxiliary cleaning chamber R12.

The first and second blocking members 31 and 32 are coupled to the first sidewall S1 to protrude to the first cleaning space C1, and the third and fourth blocking members 33 and 34 are coupled to the second sidewall S2 to protrude into the first cleaning space C1. Also, since each of the first to fourth blocking members 31, 32, 33, and 34 are tilted in a side view, the first to fourth blocking members 31, 32, 33, and 34 may block the liquid dropping down along the first and second sidewalls S1 and S2. Thus, although the liquid may be contaminated while the liquid flows down along the first and second sidewalls S1 and S2, the dropping of the liquid onto the substrate SB may be prevented by the first to fourth blocking members 31, 32, 33, and 34 to prevent the substrate SB from being contaminated.

In the current embodiment, the first to fourth blocking members 31, 32, 33, and 34 may be disposed on the first and second sidewalls S1 and S2. In another embodiment, other blocking members may be further disposed on other sidewalls of the main cleaning chamber R1 except for the first and second sidewalls S1 and S2.

An exhaust unit DP is coupled to the side part SP of the cover member 50. The side part SP is disposed on the second sidewall S2. The exhaust unit DP sucks the air supplied into the first cleaning space C1 through the second vent hole ST2 to exhaust the air in the cleaning space C1 to the outside of the main cleaning chamber R1. In the current embodiment, the exhaust unit DP may include an exhaust damper and an exhaust pump.

The first auxiliary cleaning chamber R11 has a second cleaning space C2, and the substrate input hole DR1 is disposed on a side of the first auxiliary cleaning chamber R11. Second cleaning nozzles 110, a first auxiliary nozzle 120, a second auxiliary nozzle 130, a fifth blocking member 131, and a sixth blocking member 132 are disposed within the first auxiliary cleaning chamber R11.

The second cleaning nozzles 110 are disposed above the substrate SB to spray a second cleaning solution L2 onto the substrate SB. Thus, before the substrate SB is transferred into the main cleaning chamber R1 by the transfer unit 150, the substrate SB may be cleaned in the first auxiliary cleaning chamber R11.

In the current embodiment, the second cleaning nozzles 110 may be shower nozzles. Each of the second cleaning nozzles 110 may discharge the second cleaning solution L2 at a pressure less than that of the first cleaning solution L1 that is discharged from the first cleaning nozzles 10 and 15. For example, as described above, when the first cleaning solution L1 is discharged at a pressure of about 100 bars from the first cleaning nozzles 10 and 15, the second cleaning solution L2 may be discharged at a pressure of about 50 bars from the second cleaning nozzles 110.

The first auxiliary nozzle 120 may be disposed closer to the substrate input hole DR1 than the second cleaning nozzles 110. The first auxiliary nozzle 120 supplies water onto the substrate SB. The water may be used for cleaning the substrate SB together with the second cleaning solution L2.

The second auxiliary nozzle 130 is disposed adjacent to the first substrate entrance DR2. The second auxiliary nozzle 130 vertically sprays the water onto the substrate SB. Thus, a flow of the fluid flowing from the first cleaning space C1 to the second cleaning space C2 through the first substrate entrance DR2 may be blocked by the sprayed water. In the current embodiment, the fluid may be mist that is generated when the first cleaning nozzles 10 and 15 spray the first cleaning solution L1.

The fifth blocking member 131 and the sixth blocking member 132 may be disposed on sidewalls of the first auxiliary cleaning chamber R11. Each of the fifth and sixth blocking members 131 and 132 may be coupled to one of the sidewalls to protrude into the second cleaning space C2. Also, like the first to fourth blocking members 31, 32, 33, and 34, each of the fifth and sixth blocking members 131 and 132 may be tilted upwardly in a side view. Thus, a flow of the liquid that flows down along the sidewalls of the first auxiliary cleaning chamber R11 to contaminate the substrate SB may be blocked by the fifth and sixth blocking members 131 and 132.

The second auxiliary cleaning chamber R12 has a third cleaning space C3, and the substrate output hole DR4 is disposed on a side of the second auxiliary cleaning chamber R12. Also, third cleaning nozzles 210, a third auxiliary nozzle 220, a fourth auxiliary nozzle 230, a seventh blocking member 231, and an eighth blocking member 232 are disposed within the second auxiliary cleaning chamber R12.

The third cleaning nozzles 210 are disposed above the substrate SB to spray a third cleaning solution L3 onto the substrate SB. In the current embodiment, the third cleaning nozzles 210 may be shower nozzles. Each of the third cleaning nozzles 210 may discharge the third cleaning solution L3 at a pressure less than that of the first cleaning solution L1 that is discharged from the first cleaning nozzles 10 and 15.

The third auxiliary nozzle 220 may be disposed closer to the substrate entrance DR3 than the third cleaning nozzles 210. Like the first auxiliary nozzle 120, the third auxiliary nozzle 220 supplies water that is used for cleaning the substrate SB onto the substrate SB.

The fourth auxiliary nozzle 230 is disposed adjacent to the second substrate entrance DR3. The fourth auxiliary nozzle 230 vertically sprays water onto the substrate SB. Thus, a flow of the fluid flowing from the first cleaning space C1 to the third cleaning space C3 through the second substrate entrance DR3 may be blocked by the sprayed water. In the current embodiment, the fluid may be mist that is generated when the first cleaning nozzles 10 and 15 spray the first cleaning solution L1.

The seventh blocking member 231 and the eighth blocking member 232 may be disposed on sidewalls of the third auxiliary cleaning chamber R12. Each of the seventh and eighth blocking members 231 and 232 may be coupled to one of the sidewalls to protrude into the third cleaning space C3. Also, like the first to fourth blocking members 31, 32, 33, and 34, each of the seventh and eighth blocking members 231 and 232 may be tilted upwardly in a side view. Thus, a flow of the liquid that flows down along the sidewalls of the second auxiliary cleaning chamber R12 to contaminate the substrate SB may be blocked by the seventh and eighth blocking members 231 and 232.

An air flow generation unit FU1 is coupled to the first auxiliary cleaning chamber R11. The air flow generation unit FU1 is disposed on a ceiling of the first auxiliary cleaning chamber R11. In the current embodiment, the air flow generation unit FU1 may be a fan filter unit including a fan and a filter. The air flow generation unit FU1 may purify air supplied from the outside of the substrate cleaning apparatus 100. The purified air may be supplied into the second cleaning space C2 through holes 170 disposed on the first auxiliary cleaning chamber R11.

In the current embodiment, a guide member 160 may be disposed within the second cleaning space C2. The guide member 160 may have a plate shape. The guide member 160 may traverse the inside of the second cleaning space C2 to extend to the first sidewall S1 in which the first vent hole ST1 is disposed. Thus, a portion of the air supplied from the air flow generation unit FU1 to the second cleaning space C2 may be guided to the first vent hole ST1 by the guide member 160.

Also, the other portion of the air may be exhausted through a first exhaust hole 20 disposed on at least one of the sidewalls of the first auxiliary cleaning chamber R11. As a result, the air may be circulated into the second cleaning space C2.

In the current embodiment, the substrate cleaning apparatus 100 may further include an auxiliary air flow generation unit FU2 coupled to the second auxiliary cleaning chamber R12. The auxiliary air flow generation unit FU2 is disposed on a ceiling of the second auxiliary cleaning chamber R12. The auxiliary air flow generation unit FU2 may be a fan filter unit. The auxiliary air flow generation unit FU2 may supply air into the second auxiliary cleaning chamber C3 through holes 270 disposed in the second auxiliary cleaning chamber R12. The air supplied into the second auxiliary cleaning chamber R12 may be exhausted through a second exhaust hole 21 disposed on at least one of the sidewalls of the second auxiliary cleaning chamber R12. As a result, the air may be circulated into the second cleaning space C2. Also, when the air is circulated into the second auxiliary cleaning chamber R12, the mist introduced from the main cleaning chamber R1 into the second auxiliary cleaning chamber R12 may be exhausted together with the air.

Hereinafter, a process in which the air flow generation unit FU1 and the exhaust unit DP generate an air flow within the first cleaning space C1 to exhaust the mist filled into the first cleaning space C1 will be described.

FIGS. 2A and 2B are views illustrating a state in which mist is generated in the main cleaning chamber of FIG. 1B.

Referring to FIGS. 2A and 2B, after the cleaning process is performed on the substrate SB in the first auxiliary cleaning chamber R11, the substrate SB is transferred into the main cleaning chamber R1 by the transfer unit 150. Thereafter, the first cleaning nozzles 10 and 15 spray the first cleaning solution L1 onto the substrate SB to perform the cleaning process in the main cleaning chamber R1.

In the current embodiment, the first cleaning nozzles 10 and 15 may spray the first cleaning solution L1 onto the substrate SB at a pressure of about 100 bars. Thus, the substrate SB may be cleaned by the first cleaning solution L1. In addition, the first cleaning solution L1 may clean the substrate SB by the physical force that hits the substrate SB.

During the first cleaning solution L1 is sprayed onto the substrate SB at a high pressure, mist MT of the first cleaning solution L1 may be generated by the first cleaning solution L1 that is bounced from the substrate SB. As a result, a portion of the mist MT may be spread into the first cleaning space C1. Then, the mist MT may be condensed into dew on side surfaces of the cover part CP and first and second sidewalls C1 and C2 to generate liquid LC. In this case, although the liquid LC flows down along the cover part CP and the first and second sidewalls S1 and S2, the flow of the liquid may be blocked by the first to fourth blocking members 31, 32, 33, and 34. Also, the liquid LC collected into the first to fourth blocking members 31, 32, 33, and 34 may be discharged to the outside of the main cleaning chamber R1 along a tube (see reference numeral 75 of FIG. 3C). To accelerate the discharge process, the blocking members 31, 32, 33, and 34 may incline toward the tube at a predetermined angle.

FIGS. 3A, 3B, and 3C are views illustrating an operation for exhausting the mist through the substrate cleaning apparatus 100. For reference, FIG. 3B illustrates an operation for exhausting the mist by the substrate cleaning apparatus 100 with reference to a cross-sectional view taken along line I-I′ of FIG. 1A, and FIG. 3C illustrates an operation for exhausting the mist by the substrate cleaning apparatus with reference to a cross-sectional view taken along line II-II′ of FIG. 1A.

Referring to FIGS. 3A, 3B, and 3C, after the first air flow generation unit FU1 purifies air AR supplied from the outside, the air AR is supplied into the first auxiliary cleaning chamber R11 through the holes 170. Also, the air AR supplied into the first auxiliary cleaning chamber R11 may be guided to the first vent hole ST1 by the guide member 160. As a result, the air AR may be supplied into the main cleaning chamber R1 through the first vent hole ST1.

As described above, the first vent hole ST1 has a slit shape. The slit may have a length direction parallel to the width direction D1 of the first sidewall S1 of the main cleaning chamber R1. Unlike the foregoing embodiment, if a vent hole disposed in the first sidewall has a shape corresponding to that of a cylindrical tube connecting the main cleaning chamber R1 to the first auxiliary cleaning chamber R11, air turbulence may occur around the vent hole. Thus, the air passing through the vent hole may not smoothly flow. However, in the current embodiment, since the first vent hole ST1 has the slit shape, a horizontal air flow may occur around the first vent hole ST1. As a result, the air AR may smoothly flow from the first auxiliary cleaning chamber R11 to the main cleaning chamber R1.

While the air AR flows from the first auxiliary cleaning chamber R11 to the main cleaning chamber R1, the exhaust unit DP may operate to suck the air AR flowing into the main cleaning chamber R1. Thus, the air AR supplied into the main cleaning chamber R1 may be exhausted by the exhaust unit DP through the second vent hole ST2.

Like the first vent hole ST1, the second vent hole ST2 may have a slit shape extending in the width direction D1 of the second sidewall of the main cleaning chamber R1. Thus, a horizontal air flow may occur around the second vent hole ST2 to smoothly exhaust the air AR to the outside through the second vent hole ST2.

As described above, the flow of the air AR may be controlled within the first auxiliary cleaning chamber R11 and the main cleaning chamber R1. Therefore, an air flow AF crossing the first cleaning space C1 of the main cleaning chamber R1 may be controlled by the air flow generation unit FU1 and the exhaust unit DP. In this case, even though the mist MT is generated in the first cleaning space C1, the mist MT may be easily exhausted to the outside through the second vent hole ST2 by the air flow AF. That is, the mist MT may be easily exhausted to the outside of the main cleaning chamber R1 together with the air AR that is exhausted to the outside along the above-described path.

According to the operation for removing the mist MT by the substrate cleaning apparatus, since the mist MT spread into the main cleaning chamber R1 is easily removed by using the air flow AF, it may be unnecessary to separate the cover member 50 from the main cleaning chamber R1 so as to remove the mist MT that is condensed into dew on the main cleaning chamber R1 and the cover member 50. Also, since the substrate cleaning apparatus 100 has a self-removing function for removing the mist MT that may serve as a contamination source of the substrate SB, the operation of the substrate cleaning apparatus 100 may be easier. In addition, manpower and costs required for maintaining the substrate cleaning apparatus 100 may be reduced.

The substrate cleaning apparatus according to the inventive concept may have the function that is capable of removing the mist and the liquid generated by the mist by itself The contamination of the substrate due to the mist and the liquid may be prevented by using the substrate cleaning apparatus of the inventive concept. Thus, the manpower and costs required for maintaining the substrate cleaning apparatus can be reduced.

It will be apparent to those skilled in the art that various modifications and variations can be made in the inventive concept. Thus, it is intended that the inventive concept covers the modifications and variations of this invention provided they come within the scope of the appended claims and their equivalents. Hence, the real protective scope of the inventive concept shall be determined by the technical scope of the accompanying claims.

What is claimed is:

1. A substrate cleaning apparatus of cleaning a substrate, the substrate cleaning apparatus comprising:
a main cleaning chamber having a cleaning space in which the substrate is cleaned, the main cleaning chamber comprising a sidewall in which a first vent hole is defined;
at least one first cleaning nozzle disposed in the main cleaning chamber to spray a first cleaning solution;
a cover member covering the main cleaning chamber, the cover member having one side in which a second vent hole is defined;
an air flow generation unit supplying air into the cleaning space through the first vent hole; and
an exhaust unit coupled to the one side of the cover member to suck and exhaust the air supplied into the cleaning space through the second vent hole.

2. The apparatus of claim 1, wherein the air flow generation unit and the exhaust unit generate an air flow within the cleaning space and the air flow is defined by a flow of the air crossing the cleaning space through the first and second vent holes.

3. The apparatus of claim 2, wherein the air flow generation unit and the exhaust unit exhaust mist generated from the first cleaning solution and filled into the cleaning space to the outside of the main cleaning chamber by using the air flow.

4. The apparatus of claim 2, further comprising:
a first auxiliary cleaning chamber disposed adjacent to the sidewall of the main cleaning chamber;
at least one second cleaning nozzle disposed in the first auxiliary cleaning chamber to spray a second cleaning solution;
a second auxiliary cleaning chamber facing the first auxiliary cleaning chamber with the main cleaning chamber therebetween;
at least one third cleaning nozzle disposed in the second auxiliary cleaning chamber to spray a third cleaning solution; and
a transfer unit disposed within the first auxiliary cleaning chamber, the cleaning chamber, and the second auxiliary cleaning chamber to transfer the substrate.

5. The apparatus of claim 4, wherein the air flow generation unit supplies the air into the first auxiliary cleaning chamber through a hole defined in the first auxiliary cleaning chamber, and the air supplied into the first auxiliary cleaning chamber is supplied into the cleaning space through the first vent hole.

6. The apparatus of claim 5, further comprising a guide member disposed within the first auxiliary cleaning chamber to extend to the first vent hole, wherein the guide member guides the air supplied into the first auxiliary cleaning chamber to the first vent hole.

7. The apparatus of claim 4, wherein the first cleaning nozzle sprays the first cleaning solution at a first pressure, the second cleaning nozzle sprays the second cleaning solution at a second pressure, and the third cleaning nozzle sprays the third cleaning solution at a third pressure,
wherein the first pressure is greater than each of the second and third pressures.

8. The apparatus of claim 4, further comprising:
a first auxiliary nozzle disposed within the first auxiliary cleaning chamber to spray a first fluid, the first auxiliary nozzle blocking mist generated from the first cleaning solution and introduced into the first auxiliary cleaning chamber through a first substrate entrance; and
a second auxiliary nozzle disposed within the second auxiliary cleaning chamber to spray a second fluid, the second auxiliary nozzle blocking the mist introduced into the second auxiliary cleaning chamber through a second substrate entrance,
wherein the first substrate entrance communicating with the first auxiliary cleaning chamber is defined in the main cleaning chamber and the second substrate entrance communicating with the second auxiliary cleaning chamber is defined in the main cleaning chamber.

9. The apparatus of claim 4, further comprising an auxiliary air flow generation unit supplying air into the second auxiliary cleaning chamber through a hole defined in the second auxiliary cleaning chamber to block the mist introduced into the second auxiliary cleaning chamber.

10. The apparatus of claim 4, wherein the first cleaning nozzle comprises a water jet nozzle, and each of the second and third cleaning nozzles comprises a spray nozzle or shower nozzle.

11. The apparatus of claim 1, wherein each of the first and second vent holes has a slit shape extending in a width direction of the sidewall of the main cleaning chamber.

12. The apparatus of claim 1, wherein the cover member comprises:
a side part in which the second vent hole is defined, the side part being coupled to the exhaust unit; and
a cover part coupled to the side part to cover an upper portion of the main cleaning chamber,
wherein the cover part is tilted from the second vent hole to the first vent hole in a side view.

13. The apparatus of claim 12, wherein the cover part guides the air supplied into the cleaning space through the first vent hole to the second vent hole.

14. The apparatus of claim 1, further comprising a blocking member protruding from at least one of the sidewall and other sidewalls of the main cleaning chamber to the cleaning space to block a liquid that descends along the sidewall and other sidewalls.

15. The apparatus of claim 1, wherein the first cleaning nozzle comprises a water jet nozzle.
